(19) United States
(12) Patent Application Publication
(10) Pub. No.: US 2025/0287272 A1
(43) Pub. Date: Sep. 11, 2025

(54) DIRECT ROAMING THROUGH TARGET AP MLD

(71) Applicant: Cisco Technology, Inc., San Jose, CA (US)

(72) Inventors: Binita GUPTA, San Diego, CA (US); Brian D. HART, Sunnyvale, CA (US); Malcolm M. SMITH, Richardson, TX (US); Sudhir K. JAIN, Fremont, CA (US)

(21) Appl. No.: 19/071,700

(22) Filed: Mar. 5, 2025

Related U.S. Application Data
(60) Provisional application No. 63/562,008, filed on Mar. 6, 2024.
(60) Provisional application No. 63/719,050, filed on Nov. 11, 2024.

(51) Int. Cl. H04W 36/00; H04L 9/08; H04W 64/00

(52) U.S. Cl. CPC H04W 36/0038; H04L 9/0816; H04W 64/006

(57) ABSTRACT

A station (STA) (e.g., a non-AP MLD) in a SMD is described that roams through a target AP (e.g., an AP MLD) in the same SMD as the current AP serving the STA. That is, typically roaming in a SMD is done through the serving AP. However, there are situations when the STA may lose its connection to the serving AP suddenly such as if the STA moves behind a wall or wakes up from a sleep mode in a different location. In those cases, the STA may not be able to transmit the roaming request to its serving AP. The embodiments herein provide techniques for the STA to initiate a roam to a target AP without having to associate with the target AP (assuming the target AP is in the same SMD as the serving AP).

### CROSS-REFERENCE TO RELATED APPLICATIONS

This application claims benefit of co-pending U.S. provisional patent application Ser. No. 63/562,008 filed Mar. 6, 2024, and co-pending U.S. provisional patent application Ser. No. 63/719,050 filed Nov. 11, 2024. The aforementioned related patent applications are herein incorporated by reference in their entirety.

### TECHNICAL FIELD

Embodiments presented in this disclosure generally relate to roaming in a seamless mobility domain (SMD) directly through a target access point (AP).

### BACKGROUND

Ultra-high reliability study group (UHR SG) and 11bn (Wi-Fi 8) have discussed roaming enhancements to support more reliable and seamless roaming. To achieve seamless roaming, it is desired to reduce roaming transition time and minimize delays added due to roaming related operations.

Both in planned and unplanned Wi-Fi networks, there can be Wi-Fi coverage gaps leading to dead spots for Wi-Fi connectivity. This can lead to station's (STA's) received signal strength indicator (RSSI) dropping suddenly when it moves through a coverage gap, and as a result the STA cannot perform seamless roaming through its old serving access point (AP) multi-link device (MLD). The STA needs to quickly roam to a different AP MLD to maintain connectivity, but there will be likely be some disruptions due to break-before-make roaming.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a station roaming using a target access point in a seamless mobility domain, according to one embodiment.

FIG. 2 is a flowchart for roaming using a target access point in a seamless mobility domain, according to one embodiment.

FIG. 3 is a workflow for roaming using a target access point in a seamless mobility domain without roaming preparation, according to one embodiment.

FIG. 4 is a workflow for roaming using a target access point in a seamless mobility domain with roaming preparation, according to one embodiment.

FIG. 5 illustrates pre-roaming preparation, according to one embodiment.

FIG. 6 illustrates roaming through a target AP with proactive pre-roaming preparation, according to one embodiment.

FIG. 7 illustrates capability signaling for pre-roaming preparation, according to one embodiment.

FIG. 8 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method that includes receiving, at a target access point (AP), a request from a non-AP device to roam from a serving AP currently serving the non-AP device to the target AP where the target AP and the serving AP are in a same seamless mobility domain (SMD); receiving, from the serving AP, context associated with the non-AP device at the target AP; and transmitting, from the target AP, a roaming response to the non-AP device where the roaming response is based on the context and indicates an outcome of roaming.

Another embodiment presented in this disclosure is a target AP that includes one or more memories and one or more processor communicatively coupled to the one or more memories, wherein the one or more processors are configured to, individually or collectively, perform operations. The operations include receiving a request from a non-AP device to roam from a serving AP currently serving the non-AP device to the target AP where the target AP and the serving AP are in a same SMD); receiving, from the serving AP, context associated with the non-AP device; and transmitting, from the target AP, a roaming response to the non-AP device, where the roaming response is based on the context and indicates the outcome of roaming.

Another embodiment presented in this disclosure is a non-AP device that includes one or more memories and one or more processor communicatively coupled to the one or more memories, wherein the one or more processors are configured to, individually or collectively, perform operations. The operations include transmitting, to a target AP, a request to roam from a serving AP currently serving the non-AP device to the target AP where the target AP and the serving AP are in a same SMD and where, in response to the request, the target AP fetches context associated with the non-AP device from the serving AP; and receiving a roaming response from the target AP indicating the context was successfully transferred from the serving AP to the target AP and links were setup with the target AP.

### Example Embodiments

Embodiments herein describe a station (STA) (e.g., a non-AP device or a non-AP MLD) in a SMD that roams through a target AP (e.g., an AP MLD) in the same SMD as the current AP serving the STA. That is, typically roaming in a SMD is done through the serving AP. For example, a STA can use a roaming threshold (e.g., RSSI or some other parameter) to determine when to roam from the serving AP to another AP. The STA can start the process by transmitting a roaming request to the serving AP which then negotiates with the target AP to which the STA wants to roam. However, there are situations when the STA may lose its connection to the serving AP suddenly such as if the STA moves behind a wall or wakes up from a sleep mode in a different location. In those cases, the STA may not be able to transmit the roaming request to its serving AP.

The embodiments herein provide techniques for the STA to initiate a roam to a target AP without having to associate with the target AP (assuming the target AP is in the same SMD as the serving AP). That is, a STA that has already associated with at least one AP in the SMD can initiate a roam through a target AP without having to reassociate with the target AP. Roaming through a target AP can be performed in at two scenarios where in a first scenario there is no roaming preparation done (in which case the target AP fetches context from the serving AP using a backhaul) or a second scenario where some roaming preparation was done before the roam (in which case the target AP may have to fetch less context from the serving AP, thereby resulting in a faster roam). In either case, the embodiments herein advantageously permit a STA to roam through a target AP in a SMD rather than its serving AP and without having to reassociate.

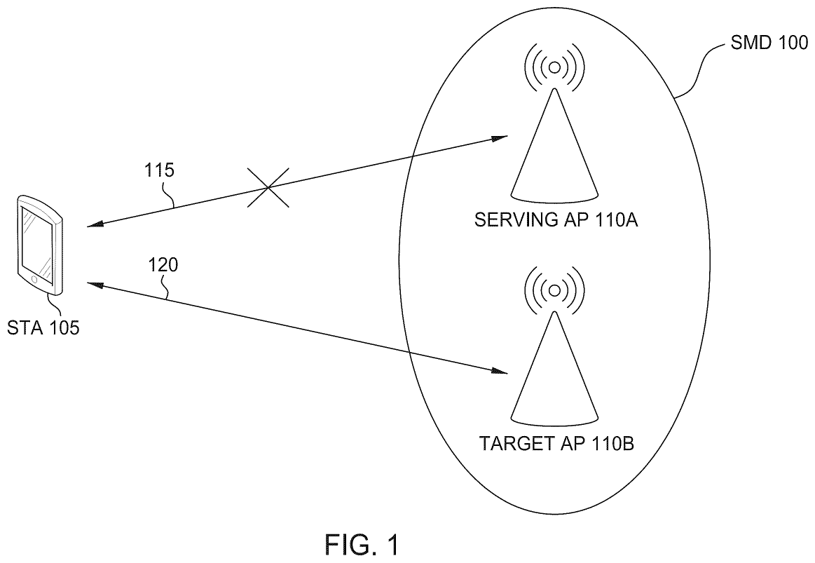

FIG. 1 illustrates a STA 105 roaming using a target AP 110B in a SMD 100, according to one embodiment. In this example, the SMD 100 includes both a serving AP 110A (which the STA 105 is currently associated with) and a target AP 110B where the STA 105 wants to roam. While two APs are shown, the SMD 100 can include any number of APs. For example, the APs in a deployment (e.g., a multi-story building, a campus, a warehouse, etc.) may be part of the same SMD 100. In one embodiment, the SMD 100 enables STAs to transition between APs without losing connectivity. The SMD 100 enables a STA to associate once to an AP in the SMD 100 and then roam seamlessly to any other AP in the SMD 100. The SMD 100 can enable services such as key sharing (e.g., pairwise transient keys) that facilitate a STA to roam seamlessly (i.e., without having to reassociate with the target AP 105B).

The arrow 115 in FIG. 1 illustrates that the STA 105 has initially associated with the service AP 110A. However, for whatever reason, the STA 105 has now decided it wants to roam to the target AP 110B as indicated by the arrow 120. For example, the connection between the serving AP 110A and the STA 105 may be lost, or may have degraded to the point where reliable wireless communication is not possible. As such, the embodiments herein are not limited to when the STA 105 can no longer communicate with the serving AP 110, and can also be used when the STA 105 can still communicate with the serving AP 110A. For example, the STA 105 may be a portable user device (e.g., a smartphone, tablet, laptop, etc.) that moves behind a wall that causes the RSSI between the STA 105 and serving AP 110A to drop suddenly. Or the STA 105 may be moved while in a sleep state, and when it wakes up can no longer communicate with the serving AP 110A (or the connection is poor). As such, roaming through the serving AP 110A may not be possible due to a lost or poor connection between the STA 105 and the serving AP 110A. Instead, as discussed below, the STA 105 can initiate roaming through the target AP 110B.

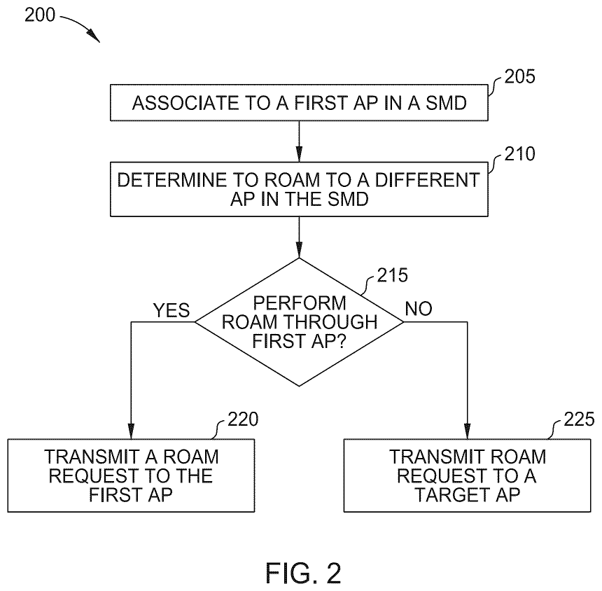

FIG. 2 is a flowchart of a method 200 for roaming using a target AP in a SMD, according to one embodiment. At block 205, the STA associates to a first AP (e.g., the serving AP) in a SMD. As part of this association, the STA and the first AP may generate a key pair which permits the two network devices to communicate using encrypted frames. For example, the STA and first AP may each generate a PMK (Pairwise Master Key) and a PTK (Pairwise Transient Key). The STA and first AP can then communicate by transmitting and receiving data in the wireless network (e.g., a Wi-Fi network).

At block 210, the STA determines to roam to a different AP in the SMD. The embodiments herein are not limited to any particular technique for determining when to roam. As one example, the STA can monitor the RSSI corresponding to the first AP, and when the RSSI fails below a threshold, determine to roam to a different AP (e.g., an AP that has a higher RSSI).

At block 215, the STA determines whether to perform the roam through the first AP (e.g., its serving AP). For example, if the STA still has a reliable connection to the first AP, the method 200 proceeds to block 220 where the STA transmits a roam request to the first AP. However, if not, the method 200 instead proceeds to block 225 where the STA transmits the roam request to a target AP to which it wants to roam.

However, in other embodiments, the STA may default to initiating a roam through a target AP rather than the serving AP (the first AP in the method 200). Thus, the embodiments herein are not limited to performing roaming through a target AP (e.g., as a backup) when the wireless connection to the serving AP is unavailable or unreliable.

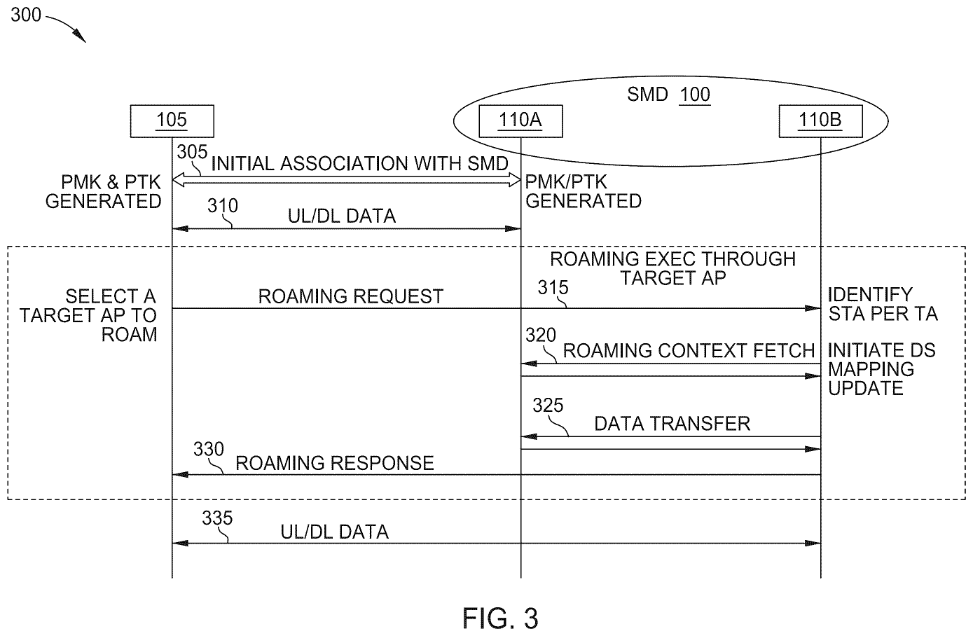

FIG. 3 is a workflow 300 for roaming using a target AP in a seamless mobility domain without roaming preparation, according to one embodiment. The workflow 300 illustrates actions performed by the STA 105, the serving AP 110B and the target AP 110B. Moreover, in FIG. 3, roaming is performed through the target AP 110B without the STA first performing roaming preparation. That is, in workflow 300, the STA 105 does not request that the serving AP 110A provide roaming information to the target AP 110B before, or in advance of, the STA 105 determining to roam to the target AP 110B.

Arrow 305 illustrates the STA 105 associating with the serving AP 110A. in one embodiment, this is the first association between the STA 105 and any AP in the SMD 100. Moreover, as part of this initial association, both the STA 105 and the serving AP 110A generate PMK and PTK pairs to enable secure/encrypted wireless communication.

Arrow 310 illustrates a time period when the STA 105 has associated with the serving AP 110A and the PMK/PTK pairs can be used to enable the STA 105 and the serving AP 110A to exchange uplink (UL) and downlink (DL) data.

Arrow 315 indicates the STA 105 transmitting a roaming request to the target AP 110B after the STA 105 has determined to roam to the target AP 110B. For example, the RSSI of the signals received at the STA 105 from the serving AP 110A may have dropped below a roaming threshold, and the STA 105 determines to roam to the target AP 110B. The STA 105 can use any suitable roaming parameter, such as basic service set (BSS) load and/or RSSI measurement of the target AP, to select the target AP 110B from one or more available target APs in the SMD 100.

In one embodiment, the roaming request is a Link Reconfiguration Request frame that signals to add one or more links with the target AP 110B. In addition, the Link Reconfiguration Request identifies the serving AP 110A and can identify the links that should be deleted for the old serving AP 110A as part of this message. However, a Link Reconfiguration Request is just one example of a frame that can be used as the roaming request. Other existing management frames, or a new management frame, can be defined to initiate roaming through the target AP 110B.

In one embodiment, a frame of the roaming request includes a Reconfiguration Multi-Link element indicating set of links to be added with the target AP 110B. In the Reconfiguration Multi-Link element, the MLD MAC Address can be set to an MLD MAC address of the target AP 110B. Alternatively, a new target MAC Address field can be defined that is set to the MLD MAC address of the target AP 110B. Moreover, in the Reconfiguration Multi-Link element, a one per-STA profile sub-element may be included for each link to be added with the target AP 110B (e.g., a target AP MLD).

The roaming request frame can also include a Reconfiguration Multi-Link element for the old serving AP 110A. The MLD MAC Address can be set to the MLD MAC address of the old serving AP 110A. The Common Info field can be extended to include a field (e.g. “Delete All Links”) which indicates to delete all links with the old serving AP 110A. Alternatively, instead of having an element in the frame to explicitly delete a link, it could be implied that the links to the serving AP 110A should be deleted when the STA 105 roams to the new target AP 110B. The links to the serving AP may be deleted after some timeout period, e.g., after a time period during which data can still be delivered to the STA from the serving AP.

Alternatively, a new information element (IE) or field can be added in the Link Reconfiguration request frame to explicitly provide ‘Serving AP MLD MAC’ and ‘Delete all links’ indication.

In addition, the roaming request frame can include a Data Transfer Request element or field(s) or another element indicating set of flows/traffic identifiers (TIDs)/Access Categories (ACs) for which the STA 105 is requesting data transfer to be performed by the target AP 110B. This request element can indicate list of TIDs, Stream Classification Service (SCS) IDs, and/or ACs for which data transfer is requested. This request element can also indicate requests to transfer data for every TID, SCS flow, and/or AC, or to transfer no data. In addition, the decision to transfer data and what data to transfer can be made by the serving AP and/or the target AP.

Moreover, the roaming request frame can indicate part of the context/agreements that are requested to be transferred (e.g. Block Acknowledgement agreements, SCS agreements, Mirrored SCS (MSCS) agreements, target wake time (TWT) agreements etc.). This can be done using a bitmap or other fields in the frame. This can also include requests for dynamic context transfer such as Sequence Number (SN) or packet number (PN) for DL and/or UL transmission. Also, the decision to transfer what context can be made by the serving AP and/or the target AP.

In one embodiment, the roaming request frame indicates the last measured RSSI at the STA for the serving AP 110A. This RSSI can be used by the target AP 110B as one of the factors in determining whether the request for data transfer should be accepted. For example, if the STA 105 has a low RSSI with the serving AP 110A (e.g., less than −70 dBm), the target AP 110B can decide to accept data transfer for that STA 105 to minimize data loss. For STAs that have a good RSSI reported in the roaming request frame with the serving AP 110A (e.g., greater than −70 dBm), the target AP 110B may not perform data transfer since STA can retrieve buffered DL data directly from the serving AP 110A.

In one embodiment, the STA 105 might want to renegotiate some portions of the context, such as renegotiate a TWP agreement that was link specific to the old serving AP 110A. The STA 105 can indicate it wants to renegotiate the context (e.g., the agreements) in the roaming request transmitted to the target AP 110B. This renegotiation can occur in a response to the roaming request frame sent from the target AP 110B to the STA 105, or after the roam has completed.

In addition, if the target AP 110B is heavily loaded, the AP 110B can advertise its congestion to the STA 105 and then the STA 105 can decide whether to request data transfer from the old serving AP 110A or the target AP 110B. Other information that can be useful to determine whether to perform data transfer at the target AP 110B can include whether the wired or wireless backhaul between the serving AP 110A and the target AP 110B is congested, if the traffic is business critical (which is information provided by the STA 105), and types of SCS flows. Also, if there is a minimum time it takes to transfer the data from the serving AP 110A to the target AP 110B, but the STA 105 needs the data sooner than that time, the STA 105 can tell the target AP 110B when it needs the data so the AP 110B can determine whether to do the data transfer. For example, if the STA 105 needs the data before the target AP 110B can transfer the data, the target AP 110B will deny the data transfer. The STA 105 can also inform the target AP 110B of the specific flows the STA 105 does, and does not, want to transfer.

In one embodiment, the roaming request is sent as an encrypted frame using a protected management frame (PMF), with the roaming request being encrypted with a shared PTK established earlier through the serving AP MLD. Using PMF, the unicast management action frames are protected from both eavesdropping and forging. Transmitting the roaming request as a PMF protected frame prevents the roaming request from being modified by a nefarious actor because the roaming request is encrypted. Moreover, when roaming through the serving AP 110A, the roaming request would be encrypted. Sending PMF protected roaming request as shown by arrow 315 to the target AP also provides encryption for the roaming request when roaming through the target AP 110B, providing similar security and privacy for the roaming request as when the roaming is performed through the serving AP. After receiving a roaming request from the STA, the target AP 110B identifies the STA based on the identifier of the STA received in the roaming request. The identifier of the STA can be either a MAC Address (which can be sent in the Transmitter Address (TA) of the request frame), a token, or a Pairwise Master Key identifier (PMKID) associated with the STA 105. In some cases, the target AP may not have the identifier of the STA locally on the target AP, and in that case it may communicate with a controller (or a network key store) to verify the STA's identifier and map it to the shared PTK. Thus, the verification of the identifier of the STA can be done locally at the target AP or with a controller (or a network key store). The target AP 110B can perform replay detection on the received roaming request based on the information included in the encrypted roaming request (e.g., a one-time use identifier or token for the STA and/or the Packet Number (PN) included in the request) to avoid replay attacks and potential Denial-of-Service attacks. In other embodiments, the roaming request to the target AP 110B may be unencrypted.

Arrow 320 illustrates the target AP 110B fetching roaming context from the serving AP 110A using, for example, a wireless or wired backhaul. That is, the target AP 110B requests a context transfer from the old serving AP 110A, which can include agreements, capabilities, association and other state information, and identifiers/tokens associated with the STA 105. As part of the roaming context transfer, the target AP 110B can also request (or fetch) security context e.g., PMK and encryption keys (e.g., a PTK) for communicating securely with the STA 105, assuming the target AP 110B has not already installed an encryption key, so the AP 110B can decrypt data (and management frames) received from the STA 105 and transmit encrypted data (and management frames) to the STA 105. The security context, which can include keys (PMK and/or PTK), may be retrieved or fetched from a key store or a controller (e.g., WLAN controller) in the network.

Arrow 325 illustrates the target AP 110 initiating a data transfer (e.g., data forwarding) from the serving AP 110A. That is, the target AP 110B can request buffered DL data for the STA 105 from the serving AP 110A, based on the roaming request received from the STA 105 and/or RSSI measurement received from the STA 105 as discussed above. This is desired to minimize/avoid the data loss during the roaming process. However, there are scenarios where it may not make sense for the target AP 110A and the serving AP 110A to perform a data transfer of the buffered DL data, such as if the RSSI is sufficient for the STA 105 to fetch its buffered DL data directly from the serving AP 110A or if the transferred data to the target AP will not be able to be delivered to the STA 105 in time to be useful (e.g. due to backhaul conditions, etc.). If data transfer is performed, the transfer of data from serving AP to target AP can continue even after the roaming response shown by arrow 330 has been sent to the STA 105.

Moreover, in addition to performing the context transfers and data transfer, the target AP 110B can initiate a distribution system (DS) mapping update for the STA 105. This lets the DS know the STA 105 is now being served by the target AP 110B so traffic destined to the STA 105 is routed to the target AP 110B. The DS mapping update can be performed after the target AP 110B has successfully received context for the STA from the serving AP 110A.

Arrow 330 illustrates the target AP 110B transmitting a roaming response frame to the STA 105 which can indicate the roaming context was successfully transferred from the serving AP 110A to the target AP 110B. For example, the target AP 110B can send a Link Reconfiguration Response frame (or another equivalent management frame) to the STA 105. In one embodiment, the response frame indicates which links were successfully added with the target AP 110B in an included Basic multi-link (ML) element or another element. The response frame can also include information on what context of the STA was successfully transferred (or renegotiated) from the serving AP to the target AP. The response frame can also include a Reconfiguration ML element to indicate that links were deleted with the old serving AP 110A by setting the MLD MAC address in the Common Info field to the old serving AP 110A MAC address and indicating with a new field in the Common Info that all links are deleted. Alternatively, a separate IE can be included to indicate the deleted link information for the serving AP 110A.

In one embodiment, the Common Info field also includes a ‘Delete links time period’ at which time the links with the serving AP 110A will be deleted. This field indicates that any buffered DL data is accessible for fetching at the serving AP 110A for that much time duration, unless that data is transferred to the target AP 110B. This time period gives the STA 105 time to fetch the data from the serving AP 110A, assuming it still has sufficient RSSI. This mechanism can also be used when roaming is initiated via the serving AP 110A. The ‘Delete links time period’ (or equivalent parameter) sent in response to a roaming request from the STA 105 can indicate to the STA 105 that it can retrieve any DL buffered data during that time period and the serving AP 110A will attempt to deliver that data to the STA 105A within that time.

If any data transfer was done, or will be done, from the serving AP 110A to the target AP 110B, in one embodiment the target AP 110B indicates that information in the response frame at arrow 330. A data transfer element/field can be included in the response frame that indicates a set of flows for which data transfer was done or will be done (if any). This request element can include a list of ACs, TIDs and/or SCS IDs for which data transfer was done or will be done. It can also indicate data transfer for all ACs, TIDs and/or SCS flows, or indicate that no data is transferred. It can also indicate whether only MAC Service Data Units (MSDUs)/aggregate MSDUs (A-MSDUs) were transferred, or all buffered data was transferred for specific TIDs or SCS flows.

In cases where partial or no data transfer was done from the serving AP 110A to the target AP 110B at arrow 325, the STA 105 can fetch DL buffered data from old serving AP 110A during the indicated ‘Delete links time period’ if it has good RSSI.

After receiving the roaming response shown by arrow 330 from the target AP, the links are added with the target AP for STA 105. Then at arrow 335 the STA 105 and the target AP 110B (now the new serving AP) can exchange UL and DL data, without the STA 105 having to go through the reassociation process with the target AP 110B.

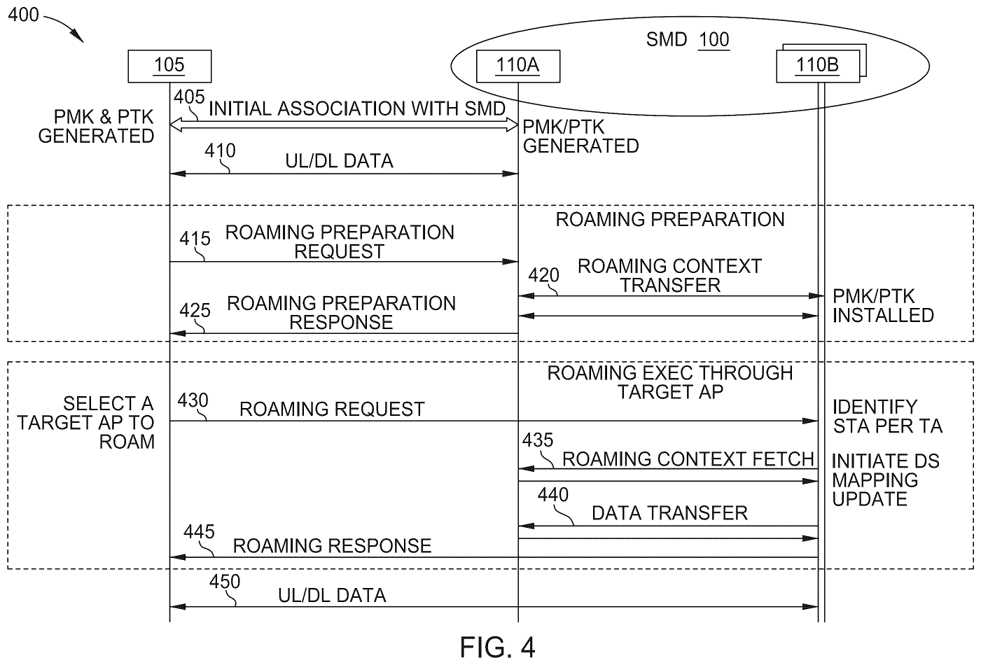

FIG. 4 is a workflow 400 for roaming using a target access point in the SMD 100 with roaming preparation, according to one embodiment.

Arrow 405 illustrates the STA 105 associating with the serving AP 110A. in one embodiment, this is the first association between the STA 105 and any AP in the SMD 100. Moreover, as part of this initial association, both the STA 105 and the serving AP 110A generate PMK and PTK pairs to enable secure/encrypted wireless communication.

Arrow 410 illustrates a time period when the STA 105 has associated with the serving AP 110A and the PMK/PTK pairs can be used to enable the STA 105 and the serving AP 110A to exchange encrypted UL and DL data.

Arrow 415 illustrates the STA 105 transmitting a roaming preparation request to the serving AP 110A. That is, the roaming preparation request is sent by the STA 105 before the STA 105 has determined it wants to roam to the target 110B. The roaming preparation request is transmitted in anticipation that the STA 105 may want to roam to the target AP 110B in the future.

In one embodiment, APs of the SMD 100 advertise the capability of supporting seamless roaming through a target AP as discussed herein in a beacon, a probe response, a (re) association response, or another management frame. Further, APs of an SMD can also advertise if the SMD 100 supports performing a pre-roaming preparation phase as discussed in FIG. 4. As discussed below, to prepare neighboring APs, the serving AP 110A can provide the target AP(s) 110B with the static roaming context for the STA 105 such as association context, security association (PMKSA, PTKSA), and a roaming MAC address (a MAC address used as Transmitter Address (TA) when roaming).

For example, the capability of “supporting seamless roaming through a target AP MLD” can be advertised in the SMD element, that provides information about the SMD or in the ultra-high reliability (UHR) capabilities. Moreover, an “expected roaming prep time for target APs” time period to perform a roaming preparation phase can be advertised by the AP which indicates the expected time after the association or the last roaming, after which the STA 105 can trigger roaming through the target AP 110B (if desired). The ‘expected roaming prep time for target APs’ can indicate the time used by the serving AP 110A to prepare one or more target APs 110B with the static context information for the non-AP MLD. This time period can also be dynamic and can be provided to the non-AP MLD in the (re) association response or roaming response.

In one embodiment, the STA 105 can explicitly tell the serving AP 110A which of the neighboring APs should be prepared for roaming through target. Moreover, after the STA 105 roams to the target AP 110B as discussed below, the STA 105 can then tell the target AP 110B which neighboring APs it should prepare for roaming incase the STA 105 has to roam again in the future. Alternatively, the SMD 100 (e.g., a network controller in the SMD 100) or the serving AP 110A may choose which neighboring APs to prepare for roaming through target. In that case, the serving AP 110A may not receive the roaming preparation request (i.e., arrow 415) from the STA 105, and instead may receive the request from a network controller, or decide on its own to prepare the target AP 110B.

Arrow 420 illustrates the serving AP 110A transferring roaming context to the target AP 110B (or to multiple target APs in the SMD 100). As mentioned above, the roaming preparation phase can be done in advance of a roam to prepare and transfer the (near) static contexts (e.g. agreements or capabilities) to the target AP 110B (or to multiple target APs in the SMD 100). As part of the preparation phase, the target AP(s) 110B install keys if it has not done so already.

Once the roaming context transfer is complete, the serving AP 110A transmits a roaming preparation response to the STA 105 as indicated by arrow 425. The response can indicate which target APs 110B are now prepared to receive the STA 105 if it decides to roam.

In another embodiment, the serving AP 110A can also dynamically inform the STA 105, using a management frame, that the serving AP 110A has prepared one or more neighboring APs (e.g., one or more target APs 110) to enable roaming directly through those target APs. The serving AP 110A can send this frame to the STA 105 after the STA 105 has performed the pre-roaming preparation with one or more neighboring AP MLDs/APs as shown by arrow 425. In one embodiment, this information can be provided to the STA 10 by sending a BSS transition management (BTM) request frame that indicates the list of neighboring APs in neighbor report elements and other fields. For example, a reason code field can list the neighboring APs that have been prepared for roaming through them (instead of through the serving AP 110A).

The serving AP 110A can also provide information on the list of neighboring AP MLDs/APs (target APs) that it has prepared in the roaming preparation response frame sent to the STA 105 as part of the roaming preparation phase, rather than after the roaming preparation phase is complete.

Arrow 430 indicates that the STA 105 has now decided to roam (using any of the parameters discussed above such as RSSI, BSS load, etc.) to the target 110B and transmits the roaming request to the target AP 110B. The roaming request in FIG. 4 can include any of the same information discussed above in the roaming request in FIG. 3 (illustrated by arrow 315).

Although there was a roaming preparation phase, in this example, the target AP 110B still performs a roaming context fetch (or transfer) as illustrated by arrow 435. However, most of the roaming context (e.g., static roaming context such quality of service (QoS), SCS, MSCS, TWT agreements and capabilities) has already been transferred as part of the roaming preparation phase. Instead, the roaming context transfer shown by arrow 435 may include dynamic context (e.g., SN and PN) which transferred during the actual roam. Moreover, the keys (PTK) may have already been installed in the roaming preparation phase. Additionally, the target AP 110B can plan in advance for resources of the roaming STA 105 based on the roaming context (e.g., SCS or TWT agreements) received in the roaming preparation phase. As such, the roaming context transfer performed at arrow 435 in FIG. 4 may take significantly less time than the roaming context transfer performed at arrow 315 in FIG. 3.

Arrow 440 indicates the target AP 110B performing a data transfer with the target AP 110A and initiate DS mapping, as discussed above in FIG. 3. As discussed in FIG. 3, there data transfer may be optional as there are some cases when the target AP 110B or the STA 105 may decide not to perform data transfer between the serving AP 110A and the target AP 110B.

Arrow 445 indicates the target AP 110B transmitting the roaming response to the STA 105 indicating the context was successfully transferred from the serving AP 110A to the target AP 110B, thereby completing the roaming process. Arrow 450 indicates the STA 105 and the target AP 110B (now the new serving AP) exchanging UL and DL data, without the STA 105 having to go through the reassociation process with the target AP 110B.

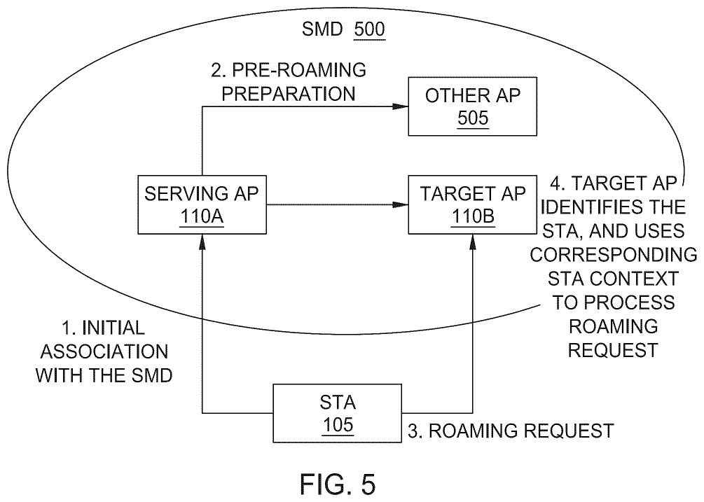

FIG. 5 illustrates pre-roaming preparation. The SMD 500 includes the serving AP 110A which can communicate with the target AP 110B as well as other APs 505 in the SMD. The serving AP 110A can proactively prepare its neighboring APs (e.g. prepare its 1-hop/2-hop neighbors or all the AP MLDs in the SMD 100 with static context of the STA 105 (e.g., a non-AP MLD) to prepare these APs for direct roaming through the target AP for the STA 105. The pre-roaming preparation (shown as step 2) can be done by the serving AP right after association with the SMD or any time after association (shown as step 1).

The serving AP 110A can proactively transfer context for the STA 105 as part of step 2, that can include one or more of following: one or more identifiers for the STA 105 (which could be one time use identifiers) such as a MAC address, a PMKID, or some token assigned to the STA 105 where multiple identifiers can be assigned to the non-AP MLD and transferred to the neighboring AP MLDs; security context, e.g., PMKSA and PTKSA of the STA 105; and whenever PTKSA is updated, the serving AP would proactively transfer the updated PTKSA to the neighboring APs in the SMD 100. In one embodiment, the transferred context for the STA in the pre-roaming preparation also includes transferring STA state (e.g. association state) and STA capabilities.

The one or more identifiers for the STA (each identifier could be MAC Address, a token, or a PMKID) can be assigned by the serving AP and provided to the STA 105 as part of the initial SMD association. Alternatively, the one or more identifiers for the STA can be generated by the STA 105 and shared with the serving AP as part of the initial SMD association. Each of the one or more identifiers for the STA can be a one-time use identifier or token, that gets used only one time by the STA when performing a roaming through the target AP. The assignment of the one or more identifiers for the STA (either by the serving AP MLD or by the STA itself and provided to the serving AP as described above) can be performed even when no pre-roaming preparation step is performed proactively by the serving AP MLD. Then the one or more identifiers for the STA can be fetched from the serving AP by the target AP (e.g., over the backhaul) to verify the STA's identity and for replay check when the target AP receives a roaming request from the STA as shown by arrow 315 (in FIG. 3) and arrow 430 (in FIG. 4).

The STA 105 includes an identifier of the STA (which could be a MAC Address, a token, or a PMKID) in the roaming request that it sends directly to a target AP 110B. If the identifier for the STA is a MAC Address, it can be provided as the TA (Transmitter Address) in the roaming request. This can also apply to the roaming requests sent in FIGS. 3 and 4 as shown by arrows 315 and 430. The target AP 110B identifies the STA based on the identifier of the STA received in the roaming request and can perform replay check based on the identifier (which can be a one-time MAC address, a token, or a PMKID). This behavior at the target AP can also apply for the embodiments illustrated in FIGS. 3 and 4. In some cases, if roaming fails, the STA can use a different identifier of the STA (generated as described above before the roaming, e.g., as part of initial SMD association or part of last roaming) when sending another roaming request to the same target AP MLD (or a different target AP MLD), because the identifier of the STA can be a one-time use identifier.

By proactively preparing neighboring APs in the SMD 100, the STA 105 can perform roaming directly through the target AP 110B or with any of the neighboring APs that are proactively prepared within the SMD. As part of the roaming procedure, the one or more identifier of the STA is generated/assigned (e.g., one or more MAC address or token) to be used for the future roaming. In one embodiment, the pre-roaming preparation step is performed again after the STA 105 roams to a new target AP 110B, to prepare neighboring AP MLDs of the target AP 110B with updated context of the STA for a future roam.

The serving AP 110A can indicate to the STA 105 that the neighboring AP(s) have been prepared (e.g. indicate that all AP MLDs in the SMD 100 or a specific set of AP MLDs are prepared) by sending an unsolicited management frame e.g. a BTM Request, an unsolicited Neighbor Report Response or another management frame. If an AP advertises a capability for performing pre-roaming preparation (e.g. in SMD element), then it can be understood that such preparation is done for all neighboring AP MLDs or all APs in the SMD 100. In that case, sending an indication to the STA for pre-roaming prep completion can be optional.

At step 3, the STA 105 transmits a roaming request directly to the target AP that includes an identifier of the STA (a MAC Address, a token or a PMKID). At step 4, the target AP identifies the STA 105 based on the identifier of the STA included in the roaming request, and uses the corresponding STA context that was received at step 2 from the serving AP 110A to process the roaming request.

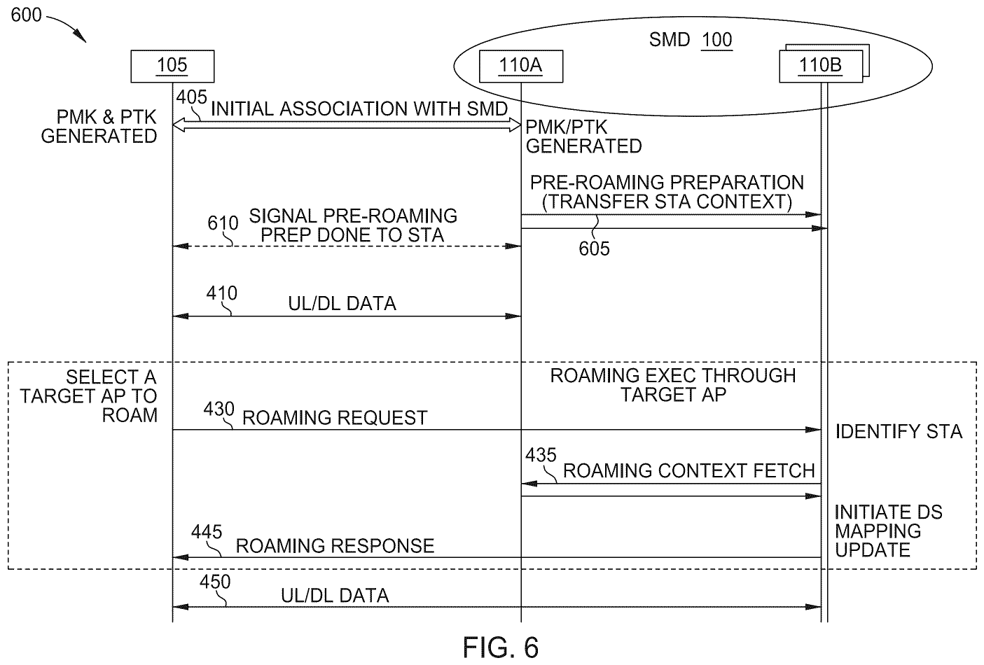

FIG. 6 illustrates roaming through a target AP with proactive pre-roaming preparation. As such, FIG. 6 can share many of the same steps as FIG. 4, as indicated by using the same reference numbers. These shared steps are not repeated here.

Arrow 405 illustrates the STA 105 associating with the serving AP 110A. in one embodiment, this is the first association between the STA 105 and any AP in the SMD 100. Moreover, as part of this initial association, both the STA 105 and the serving AP 110A generate PMK and PTK pairs to enable secure/encrypted wireless communication.

Arrow 605 illustrates the serving AP 110A proactively preparing the target AP 110B (which can include any number of APs in the SMD 100) to roam with the STA 105. For example, as discussed in FIG. 5, the serving AP 110A can transmit STA context to the target AP 110B. This context can include one or more identifiers for the STA 105 (which could be MAC Address, a token, or PMKID), security context for the STA (e.g. PMKSA and PTKSA), STA association state, other capabilities and updates associated with the STA 105, and the like.

Arrow 610 illustrates the serving AP 110A informing the STA 105 that pre-roaming preparation is complete. The message notifying the STA about the completion of the pre-roaming preparation can be a BTM Request, an unsolicited Neighbor Report Response, or another management frame where the message can indicate to the STA that all neighboring AP MLDs have been prepared, or all AP MLDs in the SMD have been prepared, or can provide a specific list of neighboring AP MLDs that have been prepared. This message can be optional if the STA 105 can determine that target APs 110B have been prepared, e.g., based on pre-roaming preparation capability announced by the AP MLDs in the SMD. The rest of the timing chart in FIG. 6 can proceed as discussed in FIG. 3.

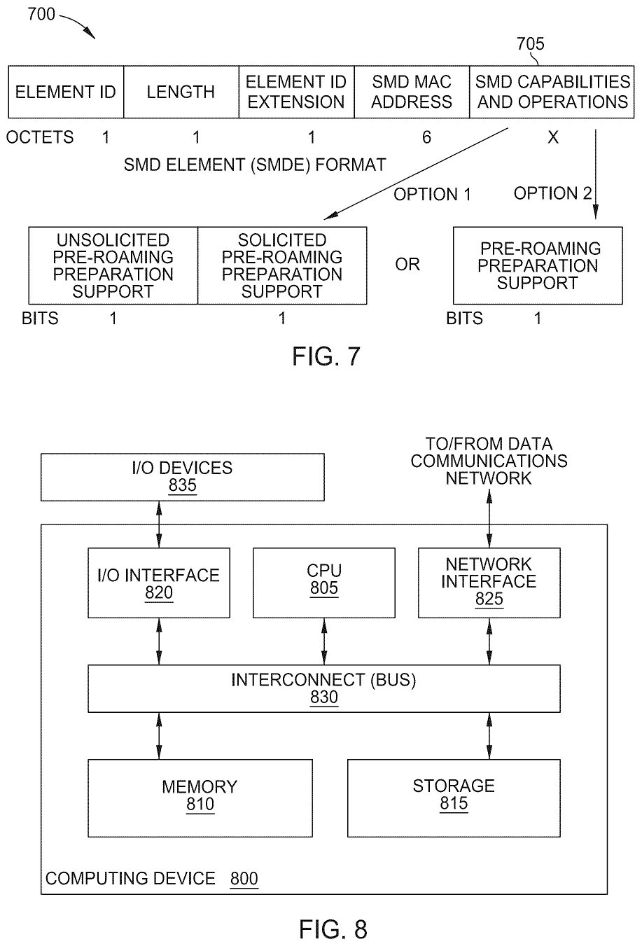

FIG. 7 illustrates capability signaling for pre-roaming preparation. The serving AP can signal capability for performing pre-roaming preparation support—e.g., capability for unsolicited and/or solicited pre-roaming preparation. This can be indicated in an element/field such as in the field 705 in the SMD element 700 or in another element.

Two options for indicating the pre-roaming preparation capability are shown for the SMD element 700 in FIG. 7. In one option (shown as Option 1) two separate capabilities for unsolicited and solicited pre-roaming preparation support can be indicated to the STA, while in another option (shown as Option 2) a single capability is indicated for pre-roaming preparation support by the serving AP. In one embodiment, this capability signaling may be same for each AP within an SMD. If the unsolicited pre-roaming preparation support capability is indicated, then the STA determines that the serving AP proactively prepares the neighboring AP MLDs for enabling the STA to roam directly through the target AP MLD. If the solicited pre-roaming preparation support capability is indicated, then the STA can request the serving AP to prepare the neighboring APs in the SMD for direct roaming through the target AP MLD. The AP can also signal a capability that direct roaming through the target AP MLD (with PMF protected roaming request frame) is always supported (e.g., in the SMD element). This could be because the target AP MLD always has a way to verify the client identifier when it receives a protected roaming request from the client. This verification can be done locally at the target AP MLD if it was prepared by the serving AP MLD previously, e.g., using the pre-roaming preparation step, or if the client identifier cannot be verified locally at the target AP, then the target AP MLD has a way to verify the client identifier with a controller (or a network key store) which is updated with the latest client identifiers.

FIG. 8 depicts an example computing device 800 configured to perform various aspects of the present disclosure, according to some embodiments disclosed herein. Although depicted as a physical device, in embodiments, the computing device 800 may be implemented using virtual device(s), and/or across a number of devices (e.g., in a cloud environment). In one embodiment, the computing device 800 corresponds to a network device (e.g., a computing system), such as the APs 110 or the STA 105.

As illustrated, the computing device 800 includes a CPU 805, memory 810, storage 815, a network interface 825, and one or more input/output (I/O) interfaces 820. In the illustrated embodiment, the CPU 805 retrieves and executes programming instructions stored in memory 810, as well as stores and retrieves application data residing in storage 815. The CPU 805 is generally representative of a single CPU and/or GPU, multiple CPUs and/or GPUs, a single CPU and/or GPU having multiple processing cores, and the like. The memory 810 is generally included to be representative of a random access memory. Storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 835 (such as keyboards, monitors, etc.) are connected via the I/O interface(s) 820. Further, via the network interface 825, the computing device 800 can be communicatively coupled with one or more other devices and components (e.g., via a network, which may include the Internet, local network(s), and the like). As illustrated, the CPU 805, memory 810, storage 815, network interface(s) 825, and I/O interface(s) 820 are communicatively coupled by one or more buses 830.

The memory 810 can include software programs or application for performing roaming through a target AP as discussed above in FIGS. 1-4. Although shown as residing in memory 810, in embodiments, the operations of discussed above (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
receiving, at a target access point (AP), a request from a non-AP device to roam from a serving AP currently serving the non-AP device to the target AP, wherein the target AP and the serving AP are in a same seamless mobility domain (SMD);
receiving, from the serving AP, context associated with the non-AP device at the target AP; and
transmitting, from the target AP, a roaming response to the non-AP device, wherein the roaming response is based on the context and indicates an outcome of roaming.

2. The method of claim 1, wherein, after transmitting the roaming response, the non-AP device roams to the target AP without having to first associate or reassociate with the target AP.

3. The method of claim 1, further comprising, after receiving the request from the non-AP device:
setting up links on the target AP for the non-AP device; and
initiating, at the target AP, a distribution system (DS) mapping update for the non-AP device that changes the mapping for the non-AP device from the serving AP to the target AP.

4. The method of claim 1, wherein the request indicates what part of the context of the non-AP device is requested to be transferred from the serving AP.

5. The method of claim 4, wherein the part of the context comprises at least one of Block Acknowledgement context, Stream Classification Service (SCS) context, Target Wake Time (TWT) context, Mirrored SCS (MSCS) context, Sequence Number or Packet Number.

6. The method of claim 1, wherein the request indicates what part of the context of the non-AP device is requested to be renegotiated with the target AP.

7. The method of claim 6, wherein the request includes the renegotiated part of the context requested by the non-AP device and the roaming response includes a result of the renegotiation.

8. The method of claim 1, further comprising, after receiving the request,
receiving, at the target AP, buffered downlink (DL) data for the non-AP device from the serving AP.

9. The method of claim 1, wherein the request from the non-AP device to roam is encrypted, wherein the method further comprises, after receiving the request at the target AP:
identifying the non-AP device based on information in the request; and
retrieving, using the identity of the non-AP device, an encryption key to decrypt the request.

10. The method of claim 9, further comprises identifying the non-AP device based on a STA identifier that is one of a MAC address, a token, or a Pairwise Master Key identifier (PMKID).

11. The method of claim 9, further comprises encrypting the roaming response with the same encryption key used to decrypt the request frame.

12. The method of claim 1, further comprising, before receiving the request from the non-AP device to roam:
preparing the target AP as a potential roaming target of the non-AP device in response to the serving AP receiving, from the non-AP device, a roaming preparation request and performing transfer of context of the non-AP device from the serving AP to the target AP based on the roaming preparation request.

13. The method of claim 1, further comprising, before receiving the request from the non-AP device to roam, preparing the target AP proactively, without being instructed by the non-AP device, as a potential roaming target of the non-AP device by transferring context of the non-AP device from the serving AP to the target AP.

14. The method of claim 13, further comprising, preparing proactively at least two APs within the SMD by transferring context of the non-AP device.

15. The method of claim 14, wherein the transferred context of the non-AP device includes one or more of security context of the non-AP device, at least one identifier for the non-AP device, at least a token for the non-AP device, or a PMKID for the non-AP device.

16. The method of claim 14, further comprising notifying the non-AP device by the serving AP that the at least two APs in the SMD are prepared for direct roaming through the target AP.

17. A target access point (AP) comprising:
one or more memories; and
one or more processor communicatively coupled to the one or more memories, wherein the one or more processors are configured to, individually or collectively, perform operations comprising:
receiving a request from a non-AP device to roam from a serving AP currently serving the non-AP device to the target AP, wherein the target AP and the serving AP are in a same seamless mobility domain (SMD);
receiving, from the serving AP, context associated with the non-AP device; and
transmitting, from the target AP, a roaming response to the non-AP device, wherein the roaming response is based on the context and indicates an outcome of roaming.

18. The target AP of claim 17, wherein the operations further comprise:
initiating a distribution system (DS) mapping update for the non-AP device that changes the mapping for the non-AP device from the serving AP to the target AP.

19. The target AP of claim 17, wherein the request indicates what part of the context of the non-AP device is requested to be transferred from the serving AP.

20. A non-AP device, comprising:
one or more memories; and
one or more processor communicatively coupled to the one or more memories, wherein the one or more processors are configured to, individually or collectively, perform operations comprising:
transmitting, to a target AP, a request to roam from a serving AP currently serving the non-AP device to the target AP, wherein the target AP and the serving AP are in a same seamless mobility domain (SMD), wherein, in response to the request, the target AP fetches context associated with the non-AP device from the serving AP; and
receiving a roaming response from the target AP indicating the context was successfully transferred from the serving AP to the target AP and links were setup with the target AP.
